(19) United States
(12) Patent Application Publication
(10) Pub. No.: US 2014/0316017 A1
(43) Pub. Date: Oct. 23, 2014

(54) THIOL GROUP-CONTAINING ACRYLATE RESIN

(71) Applicant: LANXESS Deutschland GmbH, Cologne (DE)

(72) Inventors: Pierre Vanhoorne, Monheim (DE); Michael Schelhaas, Koeln (DE)

(21) Appl. No.: 14/365,177

(22) PCT Filed: Dec. 7, 2012
(86) PCT No.: PCT/EP2012/074776

§ 371 Date: Jun. 13, 2014

(30) Foreign Application Priority Data
Dec. 22, 2011 (EP) 11195334.5

(51) Int. Cl. B01J 39/20

(52) U.S. Cl. CPC B01J 39/20
USPC 521/32

(57) ABSTRACT

The present invention relates to a process for producing novel ion exchange resins which are based on crosslinked bead polymers composed of acrylic compounds having thiol groups as functional group and have a high uptake capacity for heavy metals, and also their use for removing heavy metals from liquids, preferably process water in or from the electronics industry, the electroplating industry and the mining industry.

The present invention relates to a process for producing novel ion exchange resins which are based on crosslinked bead polymers composed of acrylic compounds having thiol groups as functional group and have a high uptake capacity for heavy metals, and also their use for removing heavy metals from liquids, preferably process water in or from the electronics industry, the electroplating industry and the mining industry.

Ion exchangers have been used for a long time for removing metals of value and heavy metals such as tin, cobalt, nickel, copper, zinc, lead, uranium, bismuth, vanadium, elements of the platinum group such as ruthenium, osmium, iridium, rhodium, rhenium, palladium, platinum and the noble metals gold and silver, in particular from aqueous solutions. For this purpose, not only cation exchangers or anion exchangers but also thiol-functionalized resins are preferably used.

Thiol-functionalized resins based on styrene bead polymers are known and are marketed, for example, by Rohm & Haas under the name Ambersep® GT74. Other commercially available resins are Ionac® SR4, Purolite® S-920 or Resintech® SIR-200. All these resins have a polystyrene backbone and benzyl thiol or phenyl thiol functionality. (WSRC-TR-2002-00046, Rev. 0, Mercury Removal Performance of Amberlite® GT-73A, Purolit® S-920, lonac® SR-4 and SIR-200® Resins, F. F. Fondeur, W. B. Van Pelt, S. D. Fink, Jan. 16, 2002, published by U.S. Department of Commerce).

Resins based on styrene generally have a low osmotic stability and are lipophilic, i.e. they are sensitive to organic impurities.

Hydroxythiol resins based on methacrylate are likewise available on the market: Spheron' Thiol 1000.

Methacrylic resins are likewise brittle and sensitive to osmotic stress. In addition, the sulfur content of the molecule is low because of the otherwise hydroxyl functionality, which corresponds to a low specific capacity.

Polymers comprising thiol-functionalized acrylates are described in the literature: Nobuharu Hisano et al.: “Entrapment of islets into reversible disulfide hydrogels”, J. Biomed. Mater. Res. 1998, 40 (1), 115-123.

Valessa Barbier et al.: “Comb-like copolymers as self-coating, low-viscosity and high-resolution matrices for DNA sequencing”, Electrophoresis 2002, 23, 1441-1449.

Stephanie A. Robb ct al.: Simultaneously Physically and Chemically Gelling Polymer System Utilizing a Poly(NIPAAm-co-cysteamine)-Based Copolymer, Biomacromolecules 2007, 8, 2294-2300.

However, all these polymers which have been described are not crosslinked beads having ion-exchange properties but instead linear polymers which can be gelled (crosslinked) via the thiol group and have applications in biochemistry and bioanalysis.

Acrylate-based ion exchangers are known and are readily available commercially, for example under the trade name Lewatit® CNP80 or Amberlite® IRA67.

Acrylate-based ion exchangers having thiol functionality are not known.

Ion exchangers which have thiol functionality and readily take up heavy metals at a sulfur content of at least 20% and high osmotic stability are sought.

The object is achieved by ion exchange resins which have at least one thiol function and can be obtained by reaction of crosslinked bead polymers composed of acrylic compounds with amino thiols, and these are accordingly provided by the present invention.

For clarification, it may be pointed out that all definitions and parameters mentioned below, either generally or in preferred ranges, are encompassed in any combinations by the scope of the invention.

In a preferred embodiment, the present invention provides acrylate-based ion exchangers having at least one thiol function, preferably having a sulfur content of at least 20%, which can be obtained by
a) reaction of an organic phase containing monomer droplets composed of at least one acrylic compound and at least one multifunctional ethylenically unsaturated compound and optionally at least one porogen and/or optionally an initiator or an initiator combination in an aqueous phase to form a crosslinked bead polymer and
b) reaction of this crosslinked bead polymer with at least one amino thiol by addition of the latter to the aqueous phase or after intermediate isolation of the bead polymers obtained from a), preferably by filtration, decantation or centrifugation, by renewed suspension of these in an aqueous phase and addition of the amino thiol.

In a preferred embodiment, step b) can be followed by
c) conversion of the acrylate-based ion exchanger having thiol functionality obtained from step b) into the Na form.

The present invention further provides a process for producing acrylate-based ion exchangers having thiol functionality, characterized in that
a) an organic phase containing monomer droplets composed of at least one acrylic compound and at least one multifunctionally ethylenically unsaturated compound and optionally at least one porogen and/or optionally an initiator or an initiator combination is reacted in an aqueous phase to form a crosslinked bead polymer and
b) this crosslinked bead polymer is reacted with at least one amino thiol by addition of the latter to the aqueous phase or, after intermediate isolation of the bead polymers obtained from a), preferably by filtration, decantation or centrifugation, and renewed suspension of these in an aqueous phase and addition of the amino thiol.

According to the invention, the acrylate-based ion exchangers having thiol functionality which can be obtained after step b) preferably have functional groups having the structures C(O)NH-alkyl-SH and/or C(O)NH-alkyl-SNa (in the case of conversion), where alkyl is a linear or branched alkyl chain having from 2 to 6 carbon atoms.

In a particularly preferred embodiment, the acrylate-based ion exchangers having thiol functionality which can be obtained after step h) have at least one functional group having the structure

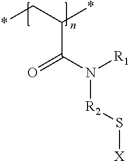

where
R₁ is H or a C₁-C₃-alkyl radical, preferably H,
R₂ is a linear or branched C₂-C₆-alkyl chain, preferably a linear C₂-chain, and
X is H or, after conversion, Na, where the range in brackets indexed by n is the polymer framework of the acrylate-based ion exchanger having thiol functionality and X is Na when a conversion as per step c) has been carried out.

The inventive acrylate-based ion exchangers having thiol functionality have a gel-like or macroporous structure, preferably a macroporous structure obtained by addition of at least one porogen to the organic phase.

In process step a), at least one acrylic compound is used as monomer and at least one multifunctionally ethylenically unsaturated compound is used as crosslinker. However, it is also possible to use mixtures of two or more acrylic compounds optionally with additional monovinylaromatic compounds as monomer and mixtures of two or more multifunctionally ethylenically unsaturated compounds as crosslinker.

For the purposes of the present invention, preference is given to using acrylic esters having branched or unbranched C₁-O₅-alkyl radicals and nitriles of acrylic acid as acrylic compounds in process step a). Particular preference is given to using methyl acrylate, butyl acrylate or acrylonitrile. Very particular preference is given to using mixtures of the acrylic compounds, in particular mixtures of methyl acrylate and acrylonitrile or of butyl acrylate and acrylonitrile.

The monovinylaromatic compounds added in a preferred embodiment are preferably styrene, methylstyrene, ethylstyrene, chlorostyrene or vinylpyridine. If they are used, these monovinylaromatic compounds are preferably added in amounts of from 0.1 to 20% by weight, preferably from 0.1 to 10% by weight, based on the total of monomers and crosslinkers.

Multifunctionally ethylenically unsaturated compounds, also referred to as crosslinkers, for the crosslinked bead polymers are preferably compounds selected from the group consisting of butadiene, isoprene, divinylbenzene, divinyltoluene, trivinylbenzene, divinylnaphthalene, trivinylnaphthalene, divinylcyclohexane, trivinylcyclohexane, triallyl cyanurate, triallylamine, 1,7-octadiene, 1,5-hexadiene, cyclopentadiene, norbornadiene, diethylene glycol divinyl ether, triethylene glycol divinyl ether, tetraethylene glycol divinyl ether, butanediol divinyl ether, ethylene glycol divinyl ether, ethylene glycol dimethacrylate, trimethylolpropane trimethacrylate, allyl methacrylate, cyclohexanedimethanol divinyl ether, hexanediol divinyl ether and trimethylolpropane trivinyl ether. Particular preference is given to using divinylbenzene, 1,7-octadiene or diethylene glycol divinyl ether. Commercial divinylbenzene grades which contain ethylvinylbenzene in addition to the isomers of divinylhenzene are sufficient. In a preferred embodiment, mixtures of different crosslinkers, particularly preferably mixtures of divinylbenzene and divinyl ether, can also be used. Very particular preference is given to using mixtures of divinylbenzene, 1,7-octadiene or diethylene glycol divinyl ether. Mixtures of divinylbenzene and 1,7-octadiene are more particularly preferred.

The multifunctionally ethylenically unsaturated compounds are preferably used in amounts of 1-20% by weight, particularly preferably 2-12% by weight, in particular 4-10% by weight, based on the total of monomers and crosslinkers. The type of multifunctionally ethylenically unsaturated compounds used as crosslinkers is selected with a view to the later use of the bead polymer.

The monomer droplets contain, in a preferred embodiment of the present invention, an initiator or mixtures of initiators for triggering the polymerization. Initiators which are preferably used for the process of the invention are peroxy compounds, particularly preferably peroxy compounds selected from the group consisting of dibenzoyl peroxide, dilauroyl peroxide, bis(p-chlorobenzoyl) peroxide, dicyclohexyl peroxydicarbonate, tert-butyl peroctoate, tert-butyl peroxy-2-ethylhexanoate, 2,5-bis(2-ethylhexanoylperoxy)-2,5-dimethylhexane and tert-amyl peroxy-2-ethylhexane and also azo compounds, preferably 2,2′-azobis(isobutyronitrile) or 2,2′-azobis(2-methylisobutyronitrile). Dibenzoyl peroxide is very particularly preferred.

The initiators are preferably used in amounts of from 0.05 to 2.5% by weight, particularly preferably from 0.1 to 1.5% by weight, based on the total of monomers and crosslinkers.

Preferred bead polymers for the purposes of the present invention, produced by process step a), have a macroporous structure. The terms macroporous and gel-like have already been comprehensively described in the technical literature (see Pure Appl. Chem., Vol. 76, No. 4, pp. 900, 2004).

To produce the macroporous structure, at least one porogen is used in the monomer droplets. Organic solvents which do not readily dissolve or swell the polymer formed are suitable for this purpose. Porogens which are preferably used are compounds selected from the group consisting of hexane, octane, isooctane, isododecane, methyl ethyl ketone, dichloroethane, dichloropropane, butanol and octanol and isomers thereof. It is also possible to use mixtures of porogens.

To produce the macroporous structure, the porogen or porogen mixture is used in amounts of from 5 to 70% by weight, preferably from 10 to 50% by weight, based on the total of monomers and crosslinkers.

Without the addition of porogen, gel-like resins are obtained and these are likewise subject matter of the present invention.

In the production of the bead polymers in process step a), the aqueous phase can, in a preferred embodiment, contain at least one dissolved polymerization inhibitor. Possible polymerization inhibitors for the purposes of the present invention are preferably both inorganic and organic materials. Particularly preferred inorganic polymerization inhibitors are nitrogen compounds selected from the group consisting of hydroxylamine, hydrazine, sodium nitrite and potassium nitrite, salts of phosphorous acid, in particular sodium hydrogenphosphite, and also sulfur-containing compounds, in particular sodium dithionite, sodium thiosulfate, sodium sulfate, sodium bisulfite, sodium thiocyanate or ammonium thiocyanate. Particularly preferred organic polymerization inhibitors are phenolic compounds selected from the group consisting of hydroquinone, hydroquinone monomethyl ether, resorcinol, catechol, tert-butylcatechol, pyrogallol and condensation products of phenols with aldehydes. Further suitable organic polymerization inhibitors are nitrogen-containing compounds. These include hydroxylamine derivatives, preferably from the group consisting of N,N-diethylhydroxylamine, N-isopropylhydroxylamine and also sulfonated or carboxylated N-alkylhydroxylamine or N,N-dialkylhydroxylamine derivatives, hydrazine derivatives, preferably N,N-hydrazinodiacetic acid, nitroso compounds, preferably N-nitrosophenylhydroxylamine, N-nitrosophenylhydroxylamine ammonium salt or N-nitrosophenylhydroxylamine aluminum salt. The concentration of the polymerization inhibitor to be used in a preferred embodiment is 5-1000 ppm (based on the aqueous phase), preferably 10-500 ppm, particularly preferably 10-250 ppm.

In a preferred embodiment, the polymerization of the monomer droplets to form spherical, monodisperse bead polymer is carried out in the presence of one or more protective colloids in the aqueous phase. Suitable protective colloids are natural or synthetic water-soluble polymers selected from the group consisting of gelatin, starch, polyvinyl alcohol, polyvinylpyrrolidone, polyacrylic acid, polymethacrylic acid and copolymers of acrylic acid or acrylic esters. According to the invention, preference is given to gelatin. Preference is likewise given according to the invention to cellulose derivatives, in particular cellulose esters or cellulose ethers, very particularly preferably carboxymethylcellulose, methylhydroxyethylcellulose, methylhydroxypropylcellulose or hydroxyethylcellulose.

Preference is also given to condensation products of aromatic sulfonic acids and formaldehyde. Particular preference is given to naphthalenesulfonic acid-formaldehyde condensates.

The protective colloids can be used either individually or as mixtures of various protective colloids. Very particular preference is given to a mixture of hydroxyethylcellulose and naphthalenesulfonic acid-formaldehyde condensate or the Na salt thereof.

The total amount of protective colloids used is preferably from 0.05 to 1% by weight, based on the aqueous phase, particularly preferably from 0.05 to 0.5% by weight.

In a preferred embodiment, the polymerization to form the spherical bead polymer in process step a) can also be carried out in the presence of a buffer system. Preference is given to buffer systems which set the pH of the aqueous phase at the beginning of the polymerization to a value in the range from 14 to 6, preferably from 12 to 8. Under these conditions, protective colloids having carboxylic acid groups are entirely or partly present as salts. The effect of the protective colloids is favorably influenced in this way. Particularly well-suited buffer systems contain phosphate or borate salts. For the purposes of the invention, the terms phosphate and borate also encompass the condensation products of the ortho forms of corresponding acids and salts. The concentration of phosphate or borate in the aqueous phase is 0.5-500 mmol/l, preferably 2.5-100 mmol/l.

In a further preferred embodiment, the polymerization to form the spherical bead polymer in process step a) can also be carried out in the presence of a salt in the aqueous phase. This reduces the solubility of the organic compounds in the water. Preferred salts are halides, sulfates or phosphates of the alkali metals and alkaline earth metals. They can be used in the concentration range up to saturation of the aqueous phase. The optimal range is therefore different for each salt and has to be tested.

Particular preference is given to sodium chloride. The preferred concentration range is 15-25% by weight, based on the aqueous phase.

The stirring speed in the polymerization has, especially at the beginning of the polymerization, a substantial influence on the particle size. Basically, smaller particles are obtained at higher stirring speeds. A person skilled in the art can control the particle size of the bead polymers within the desired range by adaptation of the stirring speed. Various types of stirrer can be used. Grid stirrers having an axial action are particularly suitable. In a 4 liter laboratory glass reactor, stirring speeds of from 100 to 400 rpm (revolutions per minute) are typically used.

The polymerization temperature depends on the decomposition temperature of the initiator used. It is preferably in the range from 50 to 180° C., particularly preferably from 55 to 130° C. The polymerization preferably takes from 0.5 hour to a number of hours, particularly preferably from 2 to 20 hours, very particularly preferably from 5 to 15 hours. It has been found to be useful to employ a temperature program in which the polymerization is commenced at a low temperature, for example 60° C., and the reaction temperature is increased as the polymerization conversion progresses. In this way, the requirement for, for example, a safe course of the reaction and a high polymerization conversion can be satisfied very well. In a preferred embodiment, the bead polymer is isolated by conventional methods, preferably by filtration, decantation or centrifugation, after the polymerization and optionally washed.

According to the invention, very particular preference is given to using acrylonitrile, methyl acrylate, divinylbenzene, 1,7-octadiene, dibenzoyl peroxide or dichloroethane in the organic phase of process step a) of the process of the invention.

According to the invention, very particular preference is given to using hydroxyethylcellulose in deionized water, sodium chloride in deionized water, the sodium salt of naphthalenesulfonic acid-formaldehyde condensate or disodium hydrogenphosphate dodecahydrate in the aqueous phase of process step a) of the process of the invention.

The bead polymers which can be obtained from process step a) preferably display bead diameters in the range from 100 μm to 2000 μm.

The crosslinked bead polymers based on acrylic compounds which are produced by process step a) are processed further in process step b) by reaction with at least one amino thiol.

Amino thiols which are preferably to be used according to the invention are liquid at room temperature. Amino thiols which are particularly preferably to be used according to the invention are compounds of the general formula H₂N-alkyl-SH, where alkyl is a linear or branched alkyl chain having from 2 to 6 carbon atoms, which are liquid at room temperature. Very particularly preference is given to compounds of the general formula R₁NH-alkyl-SH, where alkyl is a linear or branched alkyl chain having from 2 to 4 carbon atoms and R₁ is H or a C₁-C₃-alkyl radical, preferably B. which are liquid at room temperature. More particular preference is given to compounds which are liquid at room temperature and have the general formula H₂N-alkyl-SH, where alkyl is an alkyl chain having 2 carbon atoms, so that the total molecule is cysteamine.

The amino thiols are preferably used in a molar ratio, based on the ester or nitrile groups to be reacted, of from 0.7 to 8 mol, preferably in amounts of 0.8-3 mol of amino thiol per mol of ester or nitrile groups, particularly preferably from 1,0 to 1.5 mol of amino thiol per mol of ester or nitrile groups.

The reaction in process step b) is preferably carried out at temperatures of from 80 to 250° C., particularly preferably from 115 to 160° C. The reaction time is generally selected so that the nitrile or ester groups are reacted quantitatively; the achievable conversion is at least 80%, preferably at least 90%, in particular at least 95%.

The acrylate-based ion exchangers having thiol functionality which are obtained from process step b) contain, in a preferred embodiment of the present invention, at least 20% by weight of sulfur, based on the dry mass of the exchanger.

The acrylate-based ion exchangers having thiol functionality which are obtained from process step b) can be used in the SH form or after conversion into the SNa form. The conversion is carried out in process step c) which is to be carried out in a preferred embodiment by means of aqueous sodium hydroxide, preferably in the presence of sodium chloride or sodium sulfate. The conversion is preferably carried out in a column or with stirring in a vessel. A molar ratio of from 1.1 to 5 mol of NaOH per mol is preferred for complete conversion.

The acrylate-based ion exchangers having thiol functionality which are to be produced according to the invention are suitable for the adsorption of metals, in particular heavy metals and noble metals, and compounds thereof from aqueous solutions and organic liquids, preferably from acidic, aqueous solutions. The acrylate-based ion exchangers having thiol functionality which are to be produced according to the invention are particularly suitable for removing heavy metals or noble metals from aqueous solutions, in particular from aqueous solutions of alkaline earths or alkalis, from brines from chloralkali electrolysis, from aqueous hydrochloric acids, from wastewater or flue gas scrubs, and also from liquid or gaseous hydrocarbons, carboxylic acids such as adipic acid, glutaric acid or succinic acid, natural gases, natural gas condensates, mineral oils or halogenated hydrocarbons such as chlorinated or fluorinated hydrocarbons or chlorofluorocarbons. The inventive acrylate-based ion exchangers having thiol functionality are also suitable for removing heavy metals, in particular mercury, silver, cadmium or lead, from materials which are reacted during an electrolytic treatment, for example a dimerization of acrylonitrile to adiponitrile.

The acrylate-based ion exchangers having thiol functionality which are to be produced according to the invention are particularly suitable for removing mercury, iron, chromium, cobalt, nickel, copper, zinc, lead, cadmium, manganese, uranium, vanadium, ruthenium, rhodium, palladium, iridium, osmium, platinum and also gold and silver from the abovementioned solutions, liquids or gases.

The inventive acrylate-based ion exchangers having thiol functionality are more particularly suitable for removing mercury, copper, cadmium, ruthenium, rhodium, palladium, iridium, osmium, platinum and also gold and silver from the abovementioned solutions, liquids or gases.

They are also very particularly suitable for the removal or recovery of noble metal-containing catalyst residues from solutions.

Apart from metallurgy for the winning of metals of value, the acrylate-based ion exchangers having thiol functionality are also highly suitable for various fields of use in the chemical industry, the electronics industry, the waste disposal/recycling industry or electroplating technology or surface technology.

For the purposes of the present invention, deionized water is water which has a conductivity of from 0.1 to 10 μS and a content of soluble metal ions of not more than 1 ppm, preferably not more than 0.5 ppm, for Fe, Co, Ni, Mo, Cr, Cu as individual components and not more than 10 ppm, preferably not more than 1 ppm, for the sum of the metals mentioned.

With regard to the analytical methods for the present invention, the determination of the silver capacity was carried out as follows:

Loading 25 ml of resin were rinsed by means of deionized water into a plastic bottle and freed of the supernatant water by suction.

100 ml of a 75 g of Ag⁺/l silver stock solution were pipetted into a 1000 ml volumetric flask and made up to the mark with deionized water, shaken and transferred without draining to the plastic bottle.

The plastic bottle containing the solution and the resin was stirred for 16 hours.

### Titration

To determine the silver capacity, 5 ml of the diluted silver stock solution and 10 ml of the solution which has been stirred with the resin were removed and, in each case after addition of 5.5 ml of HNO3/Ca(NO3)7 solution and 7 ml of polyvinyl alcohol, titrated with a sodium chloride solution, c (NaCl)=0.1 mol/l by means of Titrino.

### Calculations

Calculation of the Ag⁺ capacity:

Consumption of 0.1 mol/l NaCl×factor×dilution=silver content

(factor: 1 ml of 0.1 mol/l NaCl=10.79 mg of Ag)

### EXAMPLE

$$Silver stock solution \text{:} 3.427 ml \cdot 10.79 \frac{mg Ag}{ml} \cdot \frac{1000 ml}{5 ml} = 7395.5 mg Ag$$

$$After 16 hours \text{:} 4.750 ml \cdot 10.79 \frac{mg Ag}{ml} \cdot \frac{995 ml}{10 ml} = 5099.6 mg Ag$$

$$Amount of Ag taken up by the resin \text{:} 7395.5 ml Ag - 5099.6 mg Ag = 2295.9 mg Ag$$

$$Amount of resin used \text{:} 25 ml$$

$$Silver capacity \text{:} 2.30 g Ag \text{/} 25 ml resin \cdot 40 = 91.8 g Ag \text{/} 1 resin$$

$$Ag equivalent weight \text{:} 107.9 g Ag \text{/} eq$$

$$Silver capacity \text{:} \frac{91.8 g Ag \text{/} 1 resin}{107.9 g \text{/} Ag \text{/} eq} = 0.85 eq \text{/} 1 resin$$

### Examples

### Example 1

### Production of the Crosslinked Bead Polymer

The polymerization was carried out in a 3 liter ground glass flange vessel provided with glass stirrer, Pt 100 temperature sensor, reflux condenser, water separator and thermostat with control unit.

Aqueous phase

| | | |
|---|---|---|
| 2.47 | g | Hydroxyethylcellulose in |
| 195 | ml | deionized water (DI water) |
| 326 | g | Sodium chloride (technical grade) in |
| 1231 | ml | DI water |
| 3.64 | g | Na salt of naphthalenesulfonic acid-formaldehyde |
| | | condensate (95% strength) in |
| 19.6 | g | disodium hydrogenphosphate dodecahydrate |

Organic phase

| | | |
|---|---|---|
| 657 | g | Acrylonitrile |
| 147 | g | Methyl acrylate |
| 42.5 | g | Divinylbenzene (80% strength) |
| 17.2 | g | 1,7-Octadiene |
| 3.53 | g | Dibenzoyl peroxide (75% strength) |
| 192 | g | Dichloroethane |

The aqueous phase was placed in the reaction vessel and the premixed organic phase was added. The mixture was then heated to 64° C. over a period of 90 minutes while stirring and this temperature was maintained for 12 hours. The mixture was then heated to 100° C. over a period of 30 minutes and this temperature was maintained for 3 hours. The mixture was then cooled and washed on a sieve.

The yield was 1130 ml or 966 g of moist product.

The dry weight was 0.72 g/ml.

### Example 2

### Production of the Crosslinked Bead Polymer Having a Different Porosity

The polymerization was carried out in a 3 liter ground glass flange vessel provided with glass stirrer, Pt 100 temperature sensor, reflux condenser, water separator and thermostat with control unit.

Aqueous phase

| | | |
|---|---|---|
| 2.74 | g | Hydroxyethylcellulose in |
| 252 | ml | deionized water (DI water) |
| 436 | g | Sodium chloride (technical grade) in |
| 1578 | ml | DI water |
| 4.7 | g | Na salt of naphthalenesulfonic acid-formaldehyde |
| | | condensate (95% strength) in |
| 18.8 | g | disodium hydrogenphosphate dodecahydrate |

Organic phase

| | | |
|---|---|---|
| 482 | g | Acrylonitrile |
| 108 | g | Methyl acrylate |
| 40.7 | g | Divinylbenzene (80% strength) |
| 12.5 | g | 1,7-Octadiene |
| 3.93 | g | Dibenzoyl peroxide (75% strength) |
| 64.3 | g | Dichloroethane |

The aqueous phase was placed in the reaction vessel and the premixed organic phase was added. The mixture was then heated to 61° C. over a period of 90 minutes while stirring and this temperature was maintained for 7 hours. The mixture was then heated to 100° C. over a period of 30 minutes and this temperature was maintained for 4 hours. The mixture was then cooled and washed on a sieve.

The yield was 855 ml or 696 g of moist product.

The dry weight was 0.72 g/ml.

### Example 3

Reaction of the crosslinked bead polymer from Example I with amino thiol, here cysteamine 100 ml of bead polymer from Example 1, 120 ml of deionized water and 160.7 g of cysteamine hydrochloride were placed in a 1 liter flange vessel provided with glass stirrer, condenser, temperature sensor and thermostat with control unit and 111 g of 50% sodium hydroxide solution were added at room temperature by means of a dropping funnel while stirring. The mixture was then refluxed for 24 hours.

The cooled mixture was washed with deionized water in a column until the washings reached a pH of about 8.

The yield was 238 ml or 205 g of moist product.

The dry weight was 0.61 g/ml.

The silver capacity was 96.7 g of silver/liter of resin, corresponding to 0.90 eq/liter of resin.

The elemental analysis was:
C: 51.3%
H: 6.9%
N: 9.9%
S: 23,1%

### Example 4

Reaction of the crosslinked bead polymer from Example 12 with amino thiol, here cysteamine

100 ml of bead polymer from Example 1, 120 ml of deionized water and 154.3 g of cysteamine hydrochloride were placed in a 1 liter flange vessel provided with glass stirrer, condenser, temperature sensor and thermostat with control unit and 107 g of 50% sodium hydroxide solution were added at room temperature by means of a dropping funnel while stirring. The mixture was then refluxed for 24 hours.

The cooled mixture was washed with deionized water in a column until the washings reached a pH of about 8.

The yield was 209 ml or 180 g of moist product.

The dry weight was 0.68 g/ml.

The silver capacity was 47.7 g of silver/liter of resin, corresponding to 0.41 eq/liter of resin.

The elemental analysis was:
C: 50.8%
H: 6.9%
N: 9.7%
S: 25.5%

What is claimed is:

1. A process for producing acrylate-based ion exchangers having thiol functionality, characterized in that
a) reaction of an organic phase containing monomer droplets composed of at least one acrylic compound and at least one multifunctionally ethylenically unsaturated compound and optionally at least one porogen and/or optionally an initiator or an initiator combination in an aqueous phase is carried out to form a crosslinked bead polymer and
b) this crosslinked bead polymer is reacted with at least one amino thiol by addition of the latter to the aqueous phase or, after intermediate isolation of the bead polymers obtained from a), preferably by filtration, decantation or centrifugation, by renewed suspension of these in an aqueous phase and addition of the amino thiol.

2. The process as claimed in claim 1, characterized in that step b) is followed by a step conversion of the acrylate-based ion exchanger having thiol functionality obtained from step b) into the Na form.

3. The process as claimed in either claim 1 or 2, characterized in that acrylic esters having branched or unbranched C₁-C₆-alkyl radicals and nitriles of acrylic acid are used as acrylic compound.

4. The process as claimed in claim 3, characterized in that methyl acrylate, butyl acrylate or acrylonitrile, preferably mixtures of methyl acrylate and acrylonitrile or of butyl acrylate and acrylonitrile, are used.

5. The process as claimed in any of claims 1 to 4, characterized in that styrene, o methylstyrene, ethylstyrene, chlorostyrene or vinylpyridine are used as monovinylaromatic compounds.

6. The process as claimed in any of claims 1 to 5, characterized in that compounds selected from the group consisting of butadiene, isoprene, divinylbenzene, divinyitoluene, trivinylbenzene, divinylnaphthalene, trivinylnaphthalene, divinylcyclohexane, trivinylcyclohexane, triallyl cyanurate, triallylamine, 1,7-octadiene, 1,5-hexadiene, cyclopentadiene, norbornadiene, diethylene glycol divinyl ether, triethylene glycol divinyl ether, tetraethylene glycol divinyl ether, butanediol divinyl ether, ethylene glycol divinyl ether, ethylene glycol dimethacrylate, trimethylolpropane trimethacrylate, allyl methacrylate, cyclohexanedimethanol divinyl ether, hexanediol divinyl ether or trimethylolpropane trivinyl ether, preferably divinylbenzene, 1,7-octadiene or diethylene glycol divinyl ether, are used as multifunctionally ethylenically unsaturated compounds.

7. The process as claimed in any of claims 1 to 6, characterized in that acrylonitrile, methyl acrylate, divinylbenzene, 1,7-octadiene, dibenzoyl peroxide or dichloroethane are used in the organic phase.

8. The process as claimed in any of claims 1 to 7, characterized in that hydroxyethylcellulose in DI water, sodium chloride in DI water, the sodium salt of naphthalenesulfonic acid-formaldehyde condensate or disodium hydrogenphosphate dodecahydrate are used in the aqueous phase, where DI water is water which has a conductivity of from 0.1 to 10 μS and a content of soluble metal ions of not more than 1 ppm for Fe, Co, Ni, Mo, Cr, Cu as individual components and not more than 10 ppm for the sum of the metals mentioned.
